(19) United States
(12) Patent Application Publication
(10) Pub. No.: US 2004/0119692 A1
(43) Pub. Date: Jun. 24, 2004

(54) Mouse with flowing decorations and alarm light

(76) Inventor: Wei Hu Liang, Chung Hua (TW)

Correspondence Address: Wei Hu Liang, 235 Chung-Ho, Box 8-24, Taipei, TW

(21) Appl. No.: 10/414,525

(22) Filed: Dec. 23, 2002

(51) Int. Cl. G09G 5/08

(52) U.S. Cl. 345/163

(57) ABSTRACT

A mouse comprises an upper cover and a base; the upper cover and the base are combined. A receiving tank is formed in the base and is located at a position to be held by the user. A plurality of flowing decorations are placed in the receiving tank. Liquid is filled into the receiving tank from an injecting hole of the receiving tank. A plug seals the injecting hole so that the flowing decorations flow in the receiving tank. In another case, a container having a shape identical to that of the receiving tank is placed in the receiving tank. A plurality of flowing decorations are placed in the container. Liquid is filled into the container from an injecting hole of the container. Moreover, a plurality of light emitting diodes are arranged around a periphery of the receiving tank of the mouse.

### FIELD OF THE INVENTION

The present invention relates to computer mice, and particularly to a computer mouse with flowing decorations and alarm light.

### BACKGROUND OF THE INVENTION

In the general design of mice, the functions of the mice are concentrated in those presented in computer screens instead of outlooks of mice. However, generally, mice have dull outlooks which can not amuse users. Thereby, there is an eager demand for a novel outlook of mice which can be varied so as to amuse the uses.

### SUMMARY OF THE INVENTION

Accordingly, the primary object of the present invention is to provide a mouse with flowing decorations and alarm light, wherein the mouse comprises an upper cover and a base. The upper cover and the base are combined integrally. A receiving tank is formed in the base and is located at a position to be held by the user. A plurality of flowing decorations are placed in the receiving tank. Liquid is filled into the receiving tank from an injecting hole of the receiving tank. A plug seals the injecting hole so that the flowing decorations flow in the receiving tank.

Another object of the present invention is to provide a mouse with flowing decorations and alarm light, wherein a container having a shape identical to that of the receiving tank is placed in the receiving tank. A plurality of flowing decorations are placed in the container. Liquid is filled into the container from an injecting hole of the container. A plug seals the injecting hole so that the flowing decorations flow in container.

A further object of the present invention is to provide a mouse with flowing decorations and alarm light, wherein a plurality of light emitting diodes LEDs are arranged around a periphery of the receiving tank of the mouse.

The various objects and advantages of the present invention will be more readily understood from the following detailed description when read in conjunction with the appended drawing.

### BRIEF DESCRIPTION OF THE DRAWINGS

FIG. 1 is a structural exploded view of the mouse with flowing decorations and alarm light of the present invention.

FIG. 1A is an exploded view showing one embodiment of the mouse with flowing decorations and alarm light of the present invention.

FIG. 2 is an assembled perspective view of the mouse with flowing decorations and alarm light of the present invention.

FIG. 3 is an assembled cross sectional view of the container of the present invention.

FIG. 4 is an elevational perspective view of the mouse with flowing decorations and alarm light of the present invention.

### BRIEF DESCRIPTION OF THE PREFERRED EMBODIMENTS

A mouse with flowing decorations and alarm light of the present invention will be described herein.

### Embodiment 1

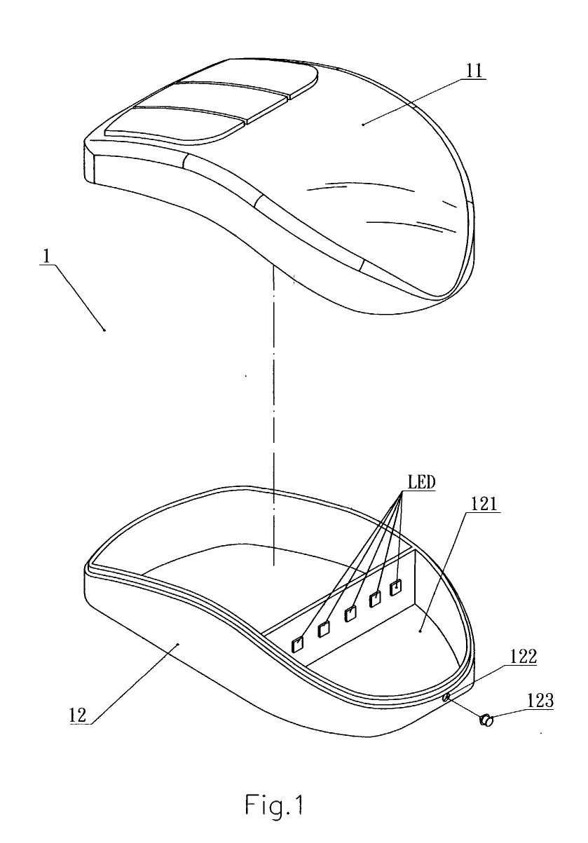

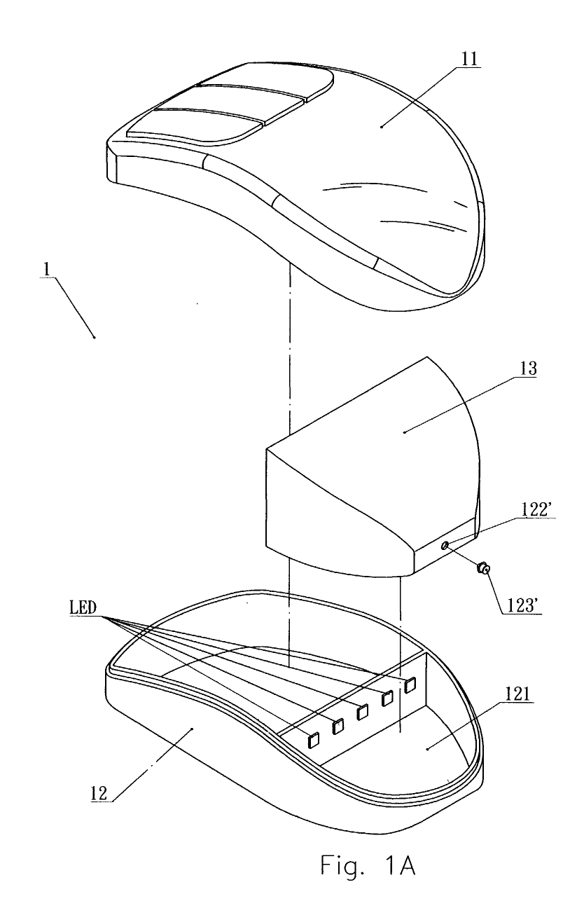

Referring to FIG. 1, the mouse 1 of the present invention includes an upper cover 11 and a base 12. The base 12 has a receiving tank 121 located at a position to be held by the user. A plurality of flowing decorations 15 are placed in the receiving tank 121. Then, the upper cover 11 and the base 12 are combined as an integral body. Then liquid 14 is filled into the receiving tank 121 from an injecting hole 122. Then a plug 123 seals the injecting hole 122 so that the flowing decorations flows in the receiving tank 121.

### Embodiment 2

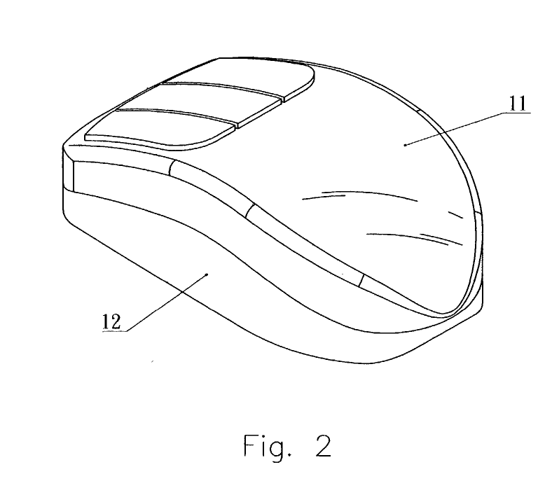

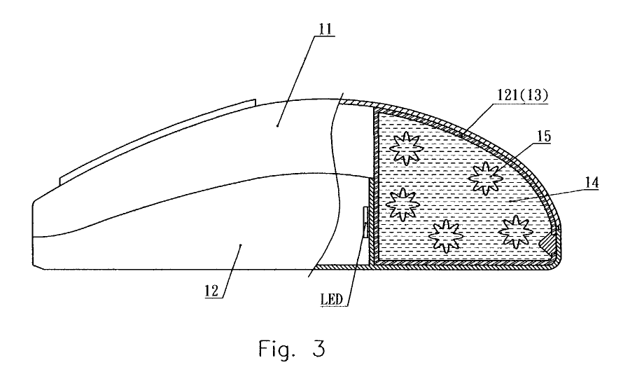

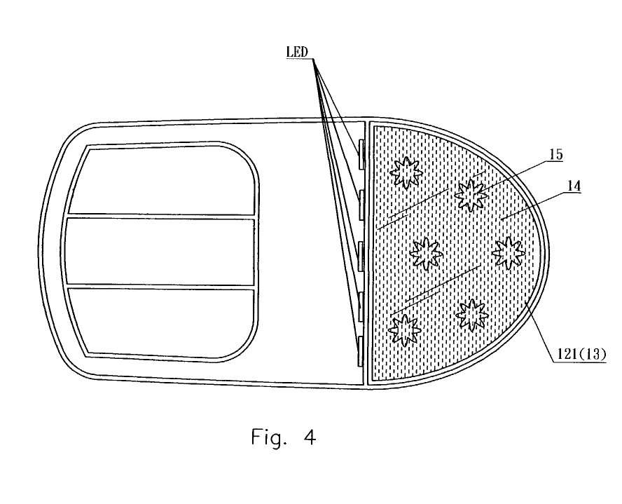

Referring to FIGS. 1A, 2, 3 and 4, in this embodiment, the upper cover 11 and base 12 are transparent, in the receiving tank 121 in the base 12 of the mouse 1, a plurality of flowing decorations 15 are placed in a container 13 having a shape identical to that of the receiving tank 121 in advance. Then, liquid 14 is placed in the container 13 from the injecting hole 122′. The injecting hole 122′ is sealed by a plug 123′. The container 13 is placed in the receiving tank 121. The upper cover 11 and base 12 are combined as an integral body so that the flowing decorations 15 are viewed from the transparent upper cover 11 and base 12.

### Embodiment 3

Referring to FIGS. 1, 1A, 2, 3 and 4, a plurality of light emitting diodes LEDs are arranged around a periphery of the receiving tank 121 of the mouse 1. A receiver circuit of a mobile phone is installed in the mouse to light up the light emitting diodes LEDs and thus the light passes through the liquid 14 in the container 13 to present various light effects. Moreover, the flowing decorations 15 present interesting effects.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

I claim:

1. A mouse with flowing decorations and alarm light, the mouse comprising:
an upper cover
a base; wherein the upper cover and the base are combined;
a receiving tank being formed in the base and being located at a position to be held by the user; a plurality of flowing decorations being placed in the receiving tank; liquid being filled into the receiving tank from an injecting hole of the receiving tank; a plug sealing the injecting hole so that the flowing decorations flows in the receiving tank.

2. A mouse with flowing decorations and alarm light as claimed in claim 1, wherein a receiver circuit of a mobile phone is installed in the mouse to light up light emitting diodes and thus the light passes through the liquid in the container to present various light effects; and thus, the flowing decorations present interesting effects.

3. A mouse with flowing decorations and alarm light, the mouse comprising:
an upper cover
a base; wherein the upper cover and the base are combined;
a receiving tank being formed in the base and being located at a position to be held by the user;
a container having a shape identical to that of the receiving tank being placed in the receiving tank; a plurality of flowing decorations being placed in the container; liquid being filled into the container from an injecting hole of the container; a plug sealing the injecting hole so that the flowing decorations flows in container.

4. A mouse with flowing decorations and alarm light as claimed in claim 3, wherein a receiver circuit of a mobile phone is installed in the mouse to light up light emitting diodes and thus the light passes through the liquid in the container to present various light effect; the flowing decorations present interesting effects.
